(19) United States
(12) Patent Application Publication
(10) Pub. No.: US 2024/0135049 A1
(43) Pub. Date: Apr. 25, 2024

(54) 2D MESHLESS METHOD FOR ANALYZING SURFACE MOUNTED PERMANENT MAGNET MACHINES

(71) Applicant: JIANGSU UNIVERSITY, Zhenjiang (CN)

(72) Inventors: Wenxiang ZHAO, Zhenjiang (TR); Yi WANG, Zhenjiang (CN); Jinghua JI, Zhenjiang (CN); Wei TIAN, Zhenjiang (CN)

(73) Assignee: JIANGSU UNIVERSITY, Zhenjiang (CN)

(21) Appl. No.: 18/276,655

(22) PCT Filed: Oct. 21, 2021
(86) PCT No.: PCT/CN2021/125118

§ 371 Date: Aug. 10, 2023

(30) Foreign Application Priority Data
Sep. 30, 2021 (CN) 202111160699.4

(51) Int. Cl. G06F 30/17

(52) U.S. Cl. CPC G06F 30/17

(57) ABSTRACT

An analysis of a surface mounted permanent magnet (SPM) machine by a 2D meshless method is provided. The 2D meshless method includes steps: discrete nodes are arranged in the region to be solved; based on Taylor expansion and weighted least squares principle, the derivative value of vector potential can be approximated as a linear combination of vector potential values of each node in the support region; partial differential equations are converted into algebraic equations; by solving the algebraic equations, the vector potential of each node can be calculated, and then the distribution of the flux line and the flux density can be obtained. According to the electromagnetic calculation constraints of the machine, parameters such as the back electromotive force and electromagnetic torque of the machine can be obtained.

### CROSS REFERENCE TO THE RELATED APPLICATIONS

This application is the national phase entry of International Application No. PCT/CN2021/125118, filed on Oct. 21, 2021, which is based upon and claims priority to Chinese Patent Application No. 202111160699.4, filed on Sep. 30, 2021, the entire contents of which are incorporated herein by reference.

### TECHNICAL FIELD

The present disclosure relates to an analysis of the surface mounted permanent magnet (SPM) machines by using 2D meshless method, which belongs to the field of electromagnetic computation.

### BACKGROUND

Permanent magnet (PM) machines have attracted more and more attention due to high reliability, high efficiency and high-power density. PM machines have been widely used in high-end fields such as electric vehicles, and aerospace. Meanwhile, an eccentric rotor shape is widely used in a SPM machine due to its excellent performance. Therefore, an appropriate electromagnetic analysis method is very important, as it directly affects design efficiency and operational performance. Mesh based numerical methods, such as finite difference method (FDM), finite element method (FEM) and boundary element method (BEM), have been quite sophisticated and successfully solved many engineering problems. However, these methods are not perfect in all cases, especially when dealing with motion and deformation. In these cases, the mesh may deform severely, which significantly affects the accuracy of the solution. It is necessary to reconstruct the mesh in these situations. However, reconstruction in complex areas is relatively difficult. In order to solve these problems, meshless methods have gradually developed. Unlike mesh-based methods, meshless methods only focus on the information of nodes. There is no connection between nodes, which is conducive to deal with moving components. Therefore, the meshless method has great potential and advantages in solving the transient magnetic field of PM machines.

### SUMMARY

The purpose of the present disclosure is to provide a method for analyzing the electromagnetic of the SPM machines, which mainly includes discretizing the solution area of the machine by nodes layout, constructing the support region, converting the partial equations into linear equations to solve. To achieve the above objects, the technical solution adopted by the present disclosure is a meshless method for analyzing SPM machines, which includes the following steps:
Step 1: Arrange nodes in each area of the machine to be solved.
Step 2: Use any node as the central node and search for a certain number of nodes closest to the central node to form a support region.
Step 3: Construct a residual function based on Taylor expansion and weighted least squares method, and approximate the derivate values of each node as a linear combination of the function values of each node in the support region.
Step 4: Convert the partial differential equation satisfied by each node in the solution region into algebraic equations.
Step 5: Conduct additional processing for the nodes at the interface and boundary according to continuity and boundary conditions.
Step 6: According to steps 4 and 5, the vector potential of each node can be obtained by solving the algebraic equations.
Step 7: Based on the vector potential of each node solved in Step 6, the flux density distribution and flux lines can be obtained; According to the electromagnetic calculation formulas, the electromagnetic parameters such as electromotive force and torque can be obtained.

Furthermore, in step 1, nodes are arranged in each solution region of the machine, at the interface between regions and at the boundary; The sub regions to be solved include stator, slot, airgap and PM; Due to the fact that the rotor core of SPM machine is generally unsaturated, the Neumann boundary can be applied for the outer surface of the rotor. Thus, there is no need to solve the rotor core region, which can improve computational efficiency.

Furthermore, in step 2, it is necessary to select any point within the sub region as the central node and find a certain number of adjacent nodes closest to the central node to form the support region; All nodes that make up the support region must be within the same sub region.

Furthermore, the specific process of step 3 is as follows: the second-order Taylor expansion is performed at the central nodes for the all nodes in the support region. Then the residual function is constructed, and the corresponding algebraic equations are obtained according to the extreme value principle; The derivative values of node can be expressed as a linear combination of function values of nodes in the support region by solving the algebraic equations.

Further, in step 4, the partial differential equation satisfied by each sub regions are converted into algebraic equations. The PM region and the air gap region satisfy the Laplace's equation. The slot region satisfies the Poisson equation. And the stator core satisfies the nonlinear partial differential equation.

Furthermore, in step 5, two support regions are formed for the nodes at the interface. Then the corresponding equations can be obtained based on the continuity conditions. The nodes distributed on the rotor face satisfy the Neumann boundary condition. The nodes distributed on the stator face satisfy the Dirichlet boundary condition.

Furthermore, in step 6, a System of Linear Algebraic Equations can be obtained; The coefficient matrix of the algebraic equations depends on the permeability, node coordinates and weight function; The source vector of the algebraic equation depends on the current density in the winding and the remanence of PM.

Furthermore, in step 7, the calculations are carried out at different rotor positions to obtain the flux leakage of each tooth in an electrical cycle. The flux line and flux density of each node can be further obtained based on the vector potential of each node by solving algebraic equations. According to the electromagnetic calculation constraints of the machine, it is possible to obtain the flux linkage that flows through each stator tooth of the machine at one time during the electrical angle period. The next rotor position is recalculated to obtain the flux of each tooth during the electrical angle period. Based on this, the three-phase flux linkage and electromotive force are obtained. If it is under load, it can be used to calculate the machine output torque.

The SPM machine of the present disclosure is a 12 slot/10 pole three-phase machine, which can be divided into four parts: stator, air gap, rotor, and shaft; The stator includes the stator yoke, stator teeth, stator slot, and armature winding; The armature slot is a flat bottom slot; The fractional slot concentrated winding configuration is adopted; The rotor is cylindrical and PMs are attached to its surface. The material of PM is neodymium iron boron grade N42UH; The shape of the PM is sector shaped and evenly distributed on the circumference of the rotor; The material of stator core and rotor core is silicon steel sheet DW310_35; The air gap is between the stator and rotor, with a thickness of 1.5 mm; The machine shaft is made of nonmagnetic material, which is a solid cylindrical.

The present disclosure has the following beneficial effects.
1. In the modeling of the present disclosure, there is no need for mesh generation like traditional numerical methods and only point placement is required; It can greatly simply preprocessing work and has good adaptability to complex machine geometric structures;
2. In the disclosure, the coefficient matrix is sparse, which is conducive to accelerating the CPU calculation speed and saving memory resources;
3. The density of nodes can be freely adjusted to balance computational efficiency and accuracy; The density of nodes can be increased to improve accuracy in areas with severe magnetic field changes. Meanwhile, the node density can be reduced to improve computational efficiency in areas with gentle magnetic field changes.

### BRIEF DESCRIPTION OF THE DRAWINGS

FIG. 1 is a 2D structural diagram of the machine used in the present disclosure.

FIG. 2 is a schematic diagram of the solution region of the present disclosure.

FIG. 3 is a schematic diagram of the interface of the present disclosure.

FIG. 4 shows the distribution of flux lines provided by finite element software.

FIG. 5 is the magnetic line distribution diagram provided by the present disclosure.

FIG. 6 is a schematic diagram comparing the no-load back electromotive provided by the finite element software and the present disclosure.

FIG. 7 is a flowchart of the method of the present disclosure.

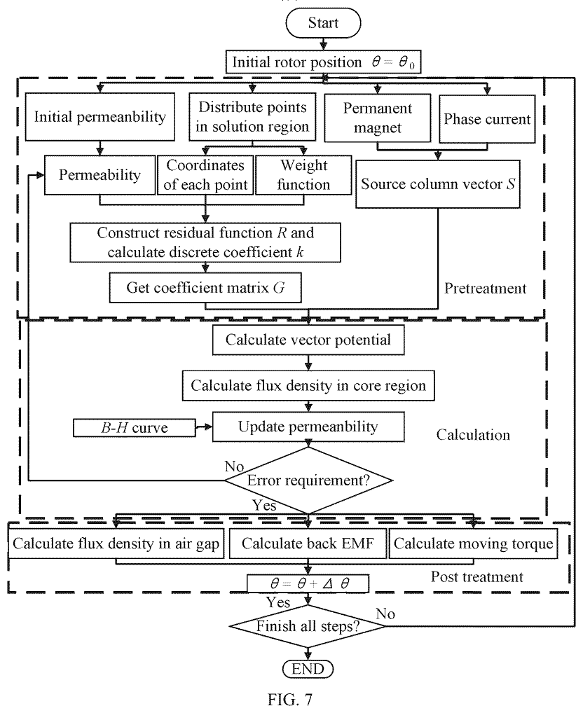

### DETAILED DESCRIPTION OF THE EMBODIMENTS

The following part will provide a clear and complete description of the technical solution in the present disclosure in conjunction with the drawings.

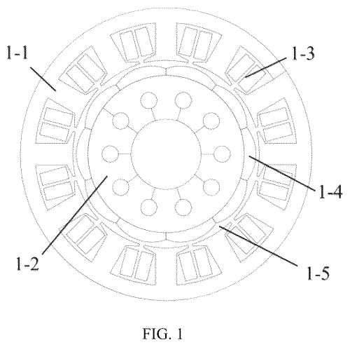

In order to explain the beneficial effects of the present disclosure more simply and clearly, a specific SPM machine will be described in detail below; FIG. 1 shows the extended structure diagram of the machine, where 1-1 represents the stator part of the machine, 1-2 represents the rotating part, 1-3 represents the stator slot, 1-4 represents PMs, and 1-5 represents air gaps; The prototype used in the present disclosure is a 12 slot 10 pole three-phase machine, which is divided into four parts: stator, air gap, rotor, and shaft; The stator includes the stator yoke, stator teeth, stator slot, and armature winding; The armature slot is a flat bottom slot; The fractional slot concentrated winding configuration is adopted; The rotor is cylindrical and PMs are attached to its surface. The material of PM is neodymium iron boron grade N42UH; The shape of the PM is sector shaped and evenly distributed on the circumference of the rotor; The materials of stator core and rotor core are both silicon steel sheet DW310_35; The air gap is between the stator and rotor, with a thickness of 1.5 mm; The machine shaft is made of nonmagnetic material, which is a solid cylindrical.

As shown in FIG. 8, the implementation includes the following steps:
Step 1: Arrange nodes in each area of the machine to be solved. The nodes are distributed within each region of the machine to be solved, at the interface between two regions and at the boundary; The sub regions to be solved include stator, slot, air gap, and PM; Due to the fact that the rotor core of surface mounted PM machine is generally unsaturated, the Neumann boundary condition can be applied for the outer surface of the rotor;
Step 2: Any node is chosen as the central node, and a predetermined number of nodes closest to the central form a support region. All nodes that form the support region must be within the same sub region.

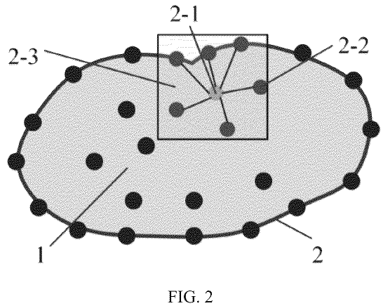

FIG. 2 is a schematic diagram of the solution region; The nodes are distributed within the area 1 and at the boundary 2 respectively. Any node within the solution area is chosen as the center node 2-1, and then a predetermined number of neighboring nodes 2-2 closest to the central node are searched to form the support region 2-3.
Step 3: A residual function is constructed based on Taylor expansion and weighted least squares method, and the derivates values of each node are approximated as a linear combination of the function values of each node in the support region.

The specific process is: the Taylor expansion is performed at the central node for all nodes in the support region. Then the expression of the remainder is obtained. Then the residual function can be achieved by multiplying the weight functions give the residual function. Finally, the corresponding algebraic equation is obtained according to the extreme value principle, and the derivative value of each node can be expressed as a linear combination of the node function values in the support region by solving the algebraic equation.

As shown in FIG. 2, in the support region 2-3, Taylor expansion is performed on the vector potential A of N surrounding nodes 2-2 at the center node 2-1.

$${A}_{n} = {A}_{o} + Δ {x}_{n} \frac{\partial {A}_{0}}{\partial x} + Δ {y}_{n} \frac{\partial {A}_{0}}{\partial y} + \frac{1}{2} Δ {x}_{n}^{2} \frac{{\partial }^{2} {A}_{0}}{\partial {x}^{2}} + \frac{1}{2} Δ {y}_{n}^{2} \frac{{\partial }^{2} {A}_{0}}{\partial {y}^{2}} + Δ {x}_{n} Δ {y}_{n} \frac{{\partial }^{2} {A}_{0}}{\partial x \partial y} + o ( {p}^{3} ) n ∈ ( 1 , N ) \qquad ( 1 )$$

where A₀ represents the vector potential value of the center node, Aₙ represents the vector potential value of the nth node around the center node, Δxₙ=xₙ−x₀ represents the difference in x coordinates, Δyₙ=yₙ−y₀ represents the difference in y coordinates, and o(p³) represents a higher-order infinitesimal, So, the residual function can be defined as:

$$R = {\sum }_{n - 1}^{N} {\{ [ {A}_{0} - {A}_{n} + Δ {x}_{n} \frac{\partial {A}_{0}}{\partial x} + Δ {y}_{n} \frac{\partial {A}_{0}}{\partial y} + \frac{1}{2} Δ {x}_{n}^{2} \frac{{\partial }^{2} {A}_{0}}{\partial {x}^{2}} + \frac{1}{2} Δ {y}_{n}^{2} \frac{{\partial }^{2} {A}_{0}}{\partial {y}^{2}} + Δ {x}_{n} Δ {y}_{n} \frac{{\partial }^{2} {A}_{0}}{\partial x \partial y} ] w ( {d}_{n} ) \}}^{2} \qquad ( 2 )$$

where Aₒ represents the vector potential value of the center node, Aₙ represents the vector potential value of the nth node around the center node, Δxₙ=xₙ−x₀ represents the difference between the x-axis of the nth node around it and the central node, Δyₙ=yₙ−y₀ represents the difference between the y-axis of the nth node around it and the central node, p=(Δxₙ²+Δyₙ²) represents the distance between two nodes, and w is the weight function. If the surrounding nodes are further away from the center node, the weight function value will be lower. Obviously, the residual function value should be as small as possible, according to the extreme value principle. There is:

$$\frac{\partial R}{\partial ( \frac{\partial {A}_{0}}{\partial x} )} = \frac{\partial R}{\partial ( \frac{\partial {A}_{0}}{\partial y} )} = \frac{\partial R}{\partial ( \frac{{\partial }^{2} {A}_{0}}{\partial {x}^{2}} )} = \frac{\partial R}{\partial ( \frac{{\partial }^{2} {A}_{0}}{\partial {y}^{2}} )} = \frac{\partial R}{\partial ( \frac{{\partial }^{2} {A}_{0}}{\partial x \partial y} )} = 0 \qquad ( 3 )$$

where, R represents the residual function defined by (2). In this way, a set of algebraic equations can be obtained:

$$FD = C \qquad ( 4 )$$

$$where$$

$$F = ( \begin{matrix}{\sum }_{n = 1}^{N} Δ {x}_{n}^{2} {w ( {d}_{n} )}^{2} & {\sum }_{n = 1}^{N} Δ {x}_{n} Δ {y}_{n} {w ( {d}_{n} )}^{2} & {\sum }_{n = 1}^{N} \frac{1}{2} Δ {x}_{n}^{3} {w ( {d}_{n} )}^{2} & {\sum }_{n = 1}^{N} \frac{1}{2} Δ {x}_{n} Δ {y}_{n}^{2} {w ( {d}_{n} )}^{2} & {\sum }_{n = 1}^{N} Δ {x}_{n}^{2} Δ {y}_{n} {w ( {d}_{n} )}^{2} \\ & {\sum }_{n = 1}^{N} Δ {y}_{n}^{2} {w ( {d}_{n} )}^{2} & {\sum }_{n = 1}^{N} \frac{1}{2} Δ {x}_{n}^{2} Δ {y}_{n} {w ( {d}_{n} )}^{2} & {\sum }_{n = 1}^{N} \frac{1}{2} Δ {y}_{n}^{3} {w ( {d}_{n} )}^{2} & {\sum }_{n = 1}^{N} Δ {x}_{n} Δ {y}_{n}^{2} {w ( {d}_{n} )}^{2} \\ & & {\sum }_{n = 1}^{N} \frac{1}{4} Δ {x}_{n}^{4} {w ( {d}_{n} )}^{2} & {\sum }_{n = 1}^{N} \frac{1}{4} Δ {x}_{n}^{2} Δ {y}_{n}^{2} {w ( {d}_{n} )}^{2} & {\sum }_{n = 1}^{N} \frac{1}{2} Δ {x}_{n}^{3} Δ {y}_{n} {w ( {d}_{n} )}^{2} \\ & & & {\sum }_{n = 1}^{N} \frac{1}{4} Δ {y}_{n}^{4} {w ( {d}_{n} )}^{2} & {\sum }_{n = 1}^{N} \frac{1}{2} Δ {x}_{n} Δ {y}_{n}^{2} {w ( {d}_{n} )}^{2} \\ Symmetric & & & & {\sum }_{n = 1}^{N} Δ {x}_{n}^{2} Δ {y}_{n}^{2} {w ( {d}_{n} )}^{2}\end{matrix} )$$

$$D = {( \begin{matrix}\frac{\partial {A}_{0}}{\partial x} & \frac{\partial {A}_{0}}{\partial y} & \frac{{\partial }^{2} {A}_{0}}{\partial {x}^{2}} & \frac{{\partial }^{2} {A}_{0}}{\partial {y}^{2}} & \frac{{\partial }^{2} {A}_{0}}{\partial x \partial y}\end{matrix} )}^{T}$$

$$and$$

$$C = ( \begin{matrix}{\sum }_{n = 1}^{N} ( {u}_{n} - {u}_{0} ) Δ {x}_{n} {w ( {d}_{n} )}^{2} \\ {\sum }_{n = 1}^{N} ( {u}_{n} - {u}_{0} ) Δ {y}_{n} {w ( {d}_{n} )}^{2} \\ {\sum }_{n = 1}^{N} ( {u}_{n} - {u}_{0} ) \frac{1}{2} Δ {x}_{n}^{2} {w ( {d}_{n} )}^{2} \\ {\sum }_{n = 1}^{N} ( {u}_{n} - {u}_{0} ) \frac{1}{2} Δ {x}_{n}^{2} {w ( {d}_{n} )}^{2} \\ {\sum }_{n = 1}^{N} ( {u}_{n} - {u}_{0} ) Δ {y}_{n} Δ {x}_{n} {w ( {d}_{n} )}^{2}\end{matrix} ) = EU$$

$$where$$

$$E = ( \begin{matrix}- {\sum }_{n = 1}^{N} Δ {x}_{n} {w ( {d}_{n} )}^{2} & Δ {x}_{1} {w ( {d}_{1} )}^{2} & … & Δ {x}_{N} {w ( {d}_{N} )}^{2} \\ - {\sum }_{n = 1}^{N} Δ {y}_{n} {w ( {d}_{n} )}^{2} & Δ {y}_{1} {w ( {d}_{1} )}^{2} & … & Δ {y}_{N} {w ( {d}_{N} )}^{2} \\ - {\sum }_{n = 1}^{N} \frac{1}{2} Δ {{x}^{2}}_{n} {w ( {d}_{n} )}^{2} & \frac{1}{2} Δ {x}_{1}^{2} {w ( {d}_{1} )}^{2} & … & \frac{1}{2} Δ {x}_{N}^{2} {w ( {d}_{N} )}^{2} \\ - {\sum }_{n = 1}^{N} \frac{1}{2} Δ {{y}^{2}}_{n} {w ( {d}_{n} )}^{2} & \frac{1}{2} Δ {y}_{1}^{2} {w ( {d}_{1} )}^{2} & … & \frac{1}{2} Δ {y}_{N}^{2} {w ( {d}_{N} )}^{2} \\ - {\sum }_{n = 1}^{N} Δ {y}_{n} Δ {x}_{n} {w ( {d}_{n} )}^{2} & Δ {y}_{1} Δ {x}_{1} {w ( {d}_{1} )}^{2} & … & Δ {y}_{N} Δ {x}_{N} {w ( {d}_{N} )}^{2}\end{matrix} )$$

$$and$$

$$U = {( \begin{matrix}{A}_{0} & {A}_{1} & {A}_{2} & …… & {A}_{N}\end{matrix} )}^{T}$$

By solving (4), the derivative values of node (xₒ,yₒ) can be expressed as a linear combination of function values of nodes in the support region:

D_{5×1}=(F_{5×5}⁻¹E_{5×(N+1)})U_{(N+1)×1}=K_{5×(N+1)}U_{(N+1)×1} (5)
Step 4: The partial differential equation satisfied by each node is converted into the algebraic equation.

The PM region and air gap region satisfy the Laplace's equation. The slot area satisfies the Poisson equation. And the stator core satisfies the two-dimensional nonlinear partial differential equation.

The vector potential of PM region 1-4 and air gap region 1-5 in FIG. 1 meet the two-dimensional Laplace's equation:

$$\frac{{\partial }^{2} A}{\partial {x}^{2}} + \frac{{\partial }^{2} A}{\partial {y}^{2}} = 0 \qquad ( 6 )$$

where A represents the vector potential, and x and y represent coordinate variables, respectively;

The discrete format of formula (6) can be written as:

$${\sum }_{i = 0}^{N} {k}_{3 , i + 1} {A}_{i} + {\sum }_{i = 0}^{N} {k}_{4 , i + 1} {A}_{i} = 0 \qquad ( 7 )$$

where A, represents the vector potential value of the i-th node in the support region, k_{3,i+1} represents the element in the third row and i+1 -th column of matrix K in formula (5) of step 3, and k_{4,i+1} represents the element in the fourth row and i+1 -th column of matrix K in formula (5). The slot regions 1-3 satisfy Poisson's equation:

$$\frac{{\partial }^{2} A}{\partial {x}^{2}} + \frac{{\partial }^{2} A}{\partial {y}^{2}} = - {μ}_{0} J \qquad ( 8 )$$

where, A represents the vector potential, x and y represent coordinate variables, respectively, μ₀ is the magnetic permeability in vacuum, and J is the current density in the slot. Similarly, its discrete format can be written as:

$${\sum }_{i = 0}^{N} {k}_{3 , i + 1} {A}_{i} + {\sum }_{i = 0}^{N} {k}_{4 , i + 1} {A}_{i} = - {μ}_{0} J \qquad ( 9 )$$

where Aᵢ represents the vector potential value of the i-th node in the support region, k_{3,i+1} represents the element in the third row and i+1-th column of matrix K in formula (5) of step 3, k_{4,i+1} represents the element in the fourth row and i+1-th column of matrix K in formula (5), μ₀ is the magnetic permeability in vacuum, and J is the current density in the slot. The stator core region meets the second-order nonlinear partial differential equation:

$$\frac{\partial v}{\partial x} \frac{\partial {A}_{c o r e}}{\partial x} + \frac{\partial v}{\partial y} \frac{\partial {A}_{c o r e}}{\partial y} + v \frac{{\partial }^{2} {A}_{c o r e}}{\partial {x}^{2}} + v \frac{{\partial }^{2} {A}_{c o r e}}{\partial {y}^{2}} = 0 \qquad ( 10 )$$

where A represents the vector potential function, x and y represent coordinate variables, and v is the magnetic permeability in the iron core. Similarly, its discrete format can be written as:

$${\sum }_{i = 0}^{N} {k}_{1 , i + 1} {v}_{i} {\sum }_{i = 0}^{N} {k}_{1 , i + 1} {A}_{i} + {\sum }_{i = 0}^{N} {k}_{2 , i + 1} {v}_{i} {\sum }_{i = 0}^{N} {k}_{2 , i + 1} {A}_{i} + {v}_{0} {\sum }_{i = 0}^{N} {k}_{3 , i + 1} {A}_{i} + {v}_{0} {\sum }_{i = 0}^{N} {k}_{4 , i + 1} {A}_{i} = 0 \qquad ( 11 )$$

where Aᵢ represents the vector magnetic potential value of the i-th node in the support region, vᵢ represents the magnetic permeability value of the i-th node in the support region, v₀ represents the magnetic permeability value of the center node, k_{1,i+1} represents the element in the first row and i+1-th column of matrix K in formula (5), k_{2,i+1} represents the element in the second row and i+1 -th column of matrix K in formula (5), k_{3,i+1} represents the element in the third row and i+1-th column of matrix K in formula (5), and k_{4,i+1} represents the element in the fourth row and i+1-th column of matrix K in formula (5).

Step 5: The additional processing is required for the nodes at the interface and the boundary. The nodes at the interface need to meet continuity conditions while the nodes at the boundary need to meet corresponding boundary conditions.

For nodes at the interface between two sub regions, it is necessary to use this node as the central node to construct the support region in each sub region. Then the corresponding equations based on the continuity conditions of magnetic field are obtained. The nodes on the rotor boundary satisfy Neumann boundary condition. The nodes on the outer surface of the stator satisfy the Dirichlet boundary condition.

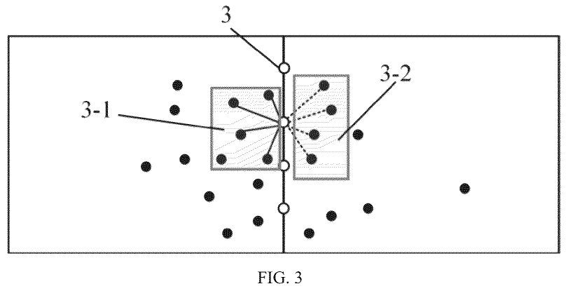

Due to the discontinuity of the derivative of the vector potential at the interface between two regions, the nodes distributed there need to be processed according to continuity conditions. Firstly, as shown in FIG. 3, it is necessary to construct support regions 3-1 and 3-2 within two regions for point 3 at the interface, respectively; Then, as described in step 4, the derivative values of the nodes at the interface in the two regions are represented as a linear combination of the function values of each point in the two support regions; Finally, the expression of continuity condition is discretization.

The vector potential at the interface of two permanents magnets satisfies the following relationship:

$$( {n}_{x} , {n}_{y} ) [ \frac{1}{μ} ( \frac{\partial {A}^{I}}{\partial y} , - \frac{\partial {A}^{I}}{\partial x} ) - ( {H}_{c x}^{I} , {H}_{c y}^{I} ) ] = ( {n}_{x} , {n}_{y} ) [ \frac{1}{μ} ( \frac{\partial {A}^{I I}}{\partial y} , - \frac{\partial {A}^{I I}}{\partial x} ) - ( {H}_{cx}^{II} , {H}_{c y}^{II} ) ] \qquad ( 12 )$$

where nₓ and n_{y} are the x-direction component and y-direction component of the unit tangent vector at the interface, A^{I} represents the vector potential in the first PM, A^{II} represents the vector potential in the second PM, μ is the permeability of the PM, and H_{cx} and H_{cy} are the x-direction and y-direction components of the coercive force of the PM, respectively. According to step 4, the derivative of equation (12) is expressed as a linear combination of function values in the support region, so the discrete format can be expressed as:

$${\sum }_{i = 0}^{N} \frac{- {n}_{y}}{μ} {k}_{1 , i + 1}^{I} {A}_{i}^{I} + {\sum }_{i = 0}^{N} \frac{{n}_{x}}{μ} {k}_{2 , i + 1}^{I} {A}_{i}^{I} - {n}_{x} {H}_{cx}^{I} - {n}_{y} {H}_{cy}^{I} = {\sum }_{i = 0}^{N} \frac{- {n}_{y}}{μ} {k}_{1 , i + 1}^{II} {A}_{i}^{II} + {\sum }_{i = 0}^{N} \frac{{n}_{x}}{μ} {k}_{2 , i + 1}^{II} {A}_{i}^{II} - {n}_{x} {H}_{cx}^{II} - {n}_{y} {H}_{cy}^{II} \qquad ( 13 )$$

where A^{I} represents the vector potential in the first PM, A^{II} represents the vector potential in the second PM, μ is the permeability of the PM, H_{cx} and H_{cy} are the x-direction and y-direction components of the coercive force of the PM, respectively, k^{I}_{1,i+1} represents the coefficient in the first region which determined by the element in the first row and i+1-th column of matrix K in formula (5), k^{I}_{2,i+1} represents the coefficient in the first region which determined by the element in the second row and i+1-th column of matrix K in formula (5), represents the coefficient in the second region which determined by the element in the first row and i+1-th column of matrix K in formula (5), k^{II}_{2,i+1} represents the coefficient in the second region which determined by the element in the second row and i+1-th column of matrix K in formula (5). At the interface between the PM and the air gap region, the vector magnetic potential satisfies the following relationship:

$$( {n}_{x} , {n}_{y} ) ( \frac{1}{μ} ( \frac{\partial {A}_{P M}}{\partial y} , - \frac{\partial {A}_{P M}}{\partial x} ) - ( {H}_{cx} , {H}_{c y} ) ) = ( {n}_{x} , {n}_{y} ) ( \frac{1}{μ} ( \frac{\partial {A}_{a i r}}{\partial y} , - \frac{\partial {A}_{a i r}}{\partial x} ) ) \qquad ( 14 )$$

where A_{PM} represents the vector potential in the PM, and Aₐᵢᵣ represents the vector potential in the air gap, μ_{PM} is the permeability of PM, μ₀ is the air permeability, while H_{cx} and H_{cy} are the x-direction and y-direction components of the coercive force of the PM, respectively. Its discrete format can be written as:

$${\sum }_{i = 0}^{N} \frac{- {n}_{y}}{{μ}_{p m}} {k}_{pm , 1 , i + 1} {A}_{pm , i} + {\sum }_{i = 0}^{N} \frac{{n}_{x}}{{μ}_{p m}} {k}_{pm , 2 , i + 1} {A}_{pm , i} - {n}_{x} {H}_{c x} - {n}_{y} {H}_{c y} = {\sum }_{i = 0}^{N} \frac{- {n}_{y}}{{μ}_{air}} {k}_{air , 1 , i + 1} {A}_{air , i} + {\sum }_{i = 0}^{N} \frac{{n}_{x}}{{μ}_{air}} {k}_{air , 2 , i + 1} {A}_{air , i} \qquad ( 15 )$$

A_{PM,i} represents the vector potential value of the i-th node in the PM, A_{air,i} represents the vector potential value of the i-th node in the air gap, μ_{PM} is the permeability of pm, μ₀ is the air permeability, H_{cx} and H_{cy} are the x-direction and y-direction components of the coercive force of the PM, respectively, k_{PM,1,i+1} represents the coefficient in the PM region, which is determined by the element in the first row, i+1 column of matrix K determined by formula (5), k_{PM,2,i+1} represents the coefficient in the PM region which determined by the element in the second row, i+1-th column of matrix K determined by formula (5), k_{air,1,i+1} represents the coefficient in the air gap region which determined by the element in the first row, i+1 column of matrix K determined by formula (5), k_{air,1,i+1} represents the coefficient in the air gap region which determined by the element in the second row, i+1-th column of matrix K determined by formula (5); At other interfaces, the vector potential satisfies the following relationship:

$$( {n}_{x} , {n}_{y} ) [ \frac{1}{{μ}_{1}} ( \frac{\partial {A}_{I}}{\partial y} , - \frac{\partial {A}_{I}}{\partial x} ) ] = ( {n}_{x} , {n}_{y} ) [ \frac{1}{{μ}_{2}} ( \frac{\partial {A}_{II}}{\partial y} , - \frac{\partial {A}_{II}}{\partial x} ) ] \qquad ( 16 )$$

where nₓ and n_{y} are the x-direction component and y-direction component of the unit tangent vector at the interface, A_{I} and A_{II} are functions of vector potential in regions I and II, μ₁ and μ₂ are the magnetic permeability of the two solving regions. The discrete format of equation (16) can be expressed as:

$${\sum }_{i = 0}^{N} \frac{- {n}_{y}}{{μ}_{1}} {k}_{1 , i + 1}^{I} {A}_{I , i} + {\sum }_{i = 0}^{N} \frac{{n}_{x}}{{μ}_{1}} {k}_{2 , i + 1}^{I} {A}_{I , i} = {\sum }_{i = 0}^{N} \frac{- {n}_{y}}{{μ}_{2}} {k}_{1 , i + 1}^{II} {A}_{II , i} + {\sum }_{i = 0}^{N} \frac{{n}_{x}}{{μ}_{2}} {k}_{2 , i + 1}^{II} {A}_{II , i} \qquad ( 17 )$$

where nₓ and n_{y} are the x-direction component and y-direction component of the unit tangent vector at the interface, A_{I} and A_{II} are functions of vector potential in regions I and II, μ₁ and μ₂ are the magnetic permeability of the two solving regions, k^{I}_{1,i+1} represents the coefficient in the first region which determined by the element in the first row, i+1-th column of matrix K determined by formula (5), k^{I}_{2,i+1} represents the coefficient in the first region which determined by the element in the second row, i+1 column of matrix K determined by formula (5), k^{II}_{1,i+1} represents the coefficient in the second region which determined by the element in the first row, i+1-th column of matrix K determined by formula (5), k^{II}_{2,i+1} represents the coefficient in the second region which determined by the element in the second row, i+1-th column of matrix K determined by formula (5); For nodes at the boundary, corresponding boundary conditions can be given. Dirichlet boundary condition can be applied for the nodes surface of the stator 1-1:

Aₛₜₐₜₒᵣ=0 (18)

where Aₛₜₐₜₒᵣ represents the vector potential value of the outer surface of the stator. Neumann boundary condition can be given for the nodes distributed on the surface of rotor 1-2.

$$n ▯ ( \frac{1}{{μ}_{P M}} ∇ \times {A}_{P M} - {H}_{c} ) = 0 \qquad ( 19 )$$

where n represents the unit tangent vector of the boundary, μ_{Pm} represents the permeability of PM, Aᵣₒₜₒᵣ represents the vector potential of the outer surface of the rotor, and H_{c} represents the coercive force; Its discrete form can be expressed as:

$${\sum }_{i = 0}^{N} \frac{- {n}_{y}}{{μ}_{P M}} {k}_{1 , i + 1} {A}_{r o t o r , i} + {\sum }_{i = 0}^{N} \frac{{n}_{x}}{{μ}_{P M}} {k}_{2 , i + 1} {A}_{r o t o r , i} - {n}_{x} {H}_{cx} - {n}_{y} {H}_{c y} = 0 \qquad ( 20 )$$

where nₓ and n_{y} are the x direction component and y direction component of the unit tangent vector on the outer surface of the rotor respectively, μ_{PM} represents the permeability of the PM, A_{rotor,i} represents the vector potential value of the node on the outer surface of the rotor, H_{cx} and H_{cy} are the x-direction and y-direction components of the coercive force of PM, k_{1,i+1} represents the element in the first row and i+1 -th column of matrix K in formula (5), and k_{2,i+1} represents the element in the second row and i+1 -th column of matrix K in formula (5).
Step 6: According to steps 4 and 5, operating on each node can get an algebraic equation, and the vector potential of each node can be obtained by solving the algebraic equations.

The coefficient matrix G of the algebraic equations depends on the permeability, node coordinates and weight function; The source matrix S depends on the current density in the slot area and the magnetization of the magnet.

According to steps 4 and 5, operating on each node can get an algebraic equation. By combining them together, a matrix equation can be obtained:

GA=S (21)

where G is the coefficient matrix, which depends on the node coordinates, weight function, and magnetic permeability; A is the column vector of vector potential to be solved, and S is the source matrix, which depends on the current density and PM magnetization. Since the permeability in the iron core is not constant, the equations (21) are nonlinear algebraic equations. Equation (21) can be solved using the successive linearization method. Its iterative scheme can be expressed as:

vⁱ=(1−f₁)v^{k+1}+f₁v^{k+1}(B^{k-1})

A^{k}=(1−f₂)A^{k-1}+f₂(G^{k})⁻¹Sₖ (22)

where Aₖ is the vector potential vector obtained from the kth calculation, Aₖ₋₁ is the vector potential vector obtained from the k−1st calculation, f₁ and f₂ are relaxation factors used to control the convergence speed, vₖ is the permeability value used for the kth calculation, vₖ₋₁ is the permeability value used for the k−1st calculation, vₖ₋₁ (Bₖ₋₁) is the permeability value obtained from the B-H curve based on the flux density Bₖ₋₁ calculated from the k−1st calculation.

Step 7: Based on the vector potential of each node solved in Step 6, the flux density distribution and the flux lines can be obtained; According to the electromagnetic calculation constraints of the machine, electromagnetic parameters such as the back electromotive force and electromagnetic torque of the machine can be calculated.

The vector potential of each node can be obtained through step 6, and the flux density of each node can be further calculated through vector potential; The flux line can be obtained by drawing the contour line of the vector potential; By using the node vector potential difference, the flux through the stator teeth of the machine at a predetermined time during the electrical angle cycle can be obtained; Based on this, the electromagnetic parameters such as three-phase flux linkage and induced electromotive force of the machine are obtained; If it is under load, it can be used to calculate the output torque of machine. In order to verify the accuracy and reliability of the 2D meshless analysis method for analyzing SPM machine proposed by the disclosure, the results obtained by the FEA commercial software are used for comparative verification.

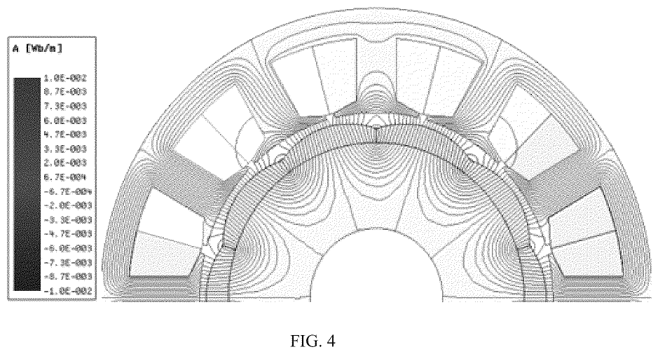

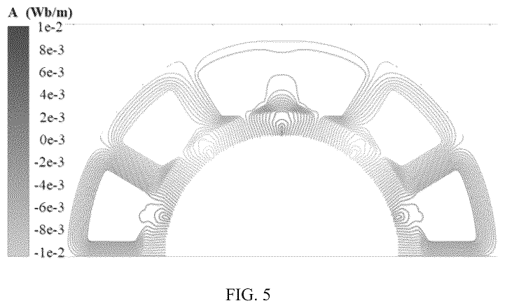

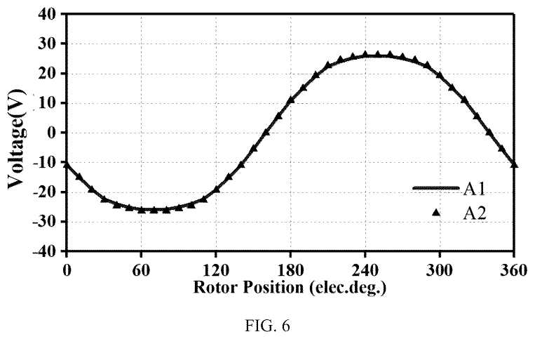

FIG. 4 shows the distribution of flux lines given by the finite element method; FIG. 5 shows the flux line distribution given by the meshless method of the disclosure; The results obtained by the two methods are very close. FIG. 6 compares the results of the back electromotive force, where A1 is the waveform obtained by the FEA software and A2 is the waveform obtained by the meshless method of the disclosure.

In summary, a 2D meshless method for analyzing the SPM machine of the present disclosure includes discretizing the solution region of the machine by nodes distribution; For each discrete node in the region, the closest nodes to the central node to are searched form a support region; Based on Taylor expansion and weighted least squares principle, the derivative values of each discrete node's vector potential can be approximated as a linear combination of the vector potential values of each node in the support region; In this way, the partial differential equation satisfied by vector potential can be converted into algebraic equations; For nodes at the interface between two regions, the additional processing based on continuity conditions is required; The nodes at the boundary will meet the corresponding boundary conditions; The algebraic equations can be obtained by performing such operations on nodes; The number of algebraic equations is equal to the number of discrete nodes; The vector potential of each node can be obtained by solving the algebraic equations, and then the distribution of flux lines and flux density can be obtained. According to the electromagnetic calculation constraints of the machine, the parameters such as the back electromotive force and electromagnetic torque of the machine can be obtained. The present disclosure conducts meshless modeling analysis for SPM machines, and the proposed scheme can provide reference research for this type of SPM machines.

Although the present disclosure has been disclosed in preferred embodiments, the embodiments are not intended to limit the present disclosure. Without departing from the spirit and scope of the present disclosure, any equivalent changes or embellishments made shall fall within the scope of protection limited by the claims attached to this application.

What is claimed is:

1. A 2D meshless method for analyzing a surface mounted permanent magnet (SPM) synchronous machine, comprising the following steps:
step 1: arranging nodes in each area of a machine to be solved;
step 2: choosing any node as a central node, and searching a predetermined number of nodes closest to the central node to form a support region;
step 3: constructing a residual function based on a Taylor expansion and weighted least squares method, and approximating derivative values of each node as a linear combination of function values of each node in the support region;
step 4: converting a partial differential equation satisfied by each node in the support region into algebraic equations;
step 5: conducting an additional processing for the nodes at an interface and boundary, wherein the nodes at the interface need to meet continuity conditions, while the nodes at the boundary need to meet corresponding boundary conditions;
step 6: according to step 4 and step 5, each node obtaining an algebraic equation, wherein a vector potential of each discrete node is obtained by solving the algebraic equations; and
step 7: based on the vector potential of each discrete node solved in step 6, obtaining a flux density distribution and magnetic lines; according to electromagnetic calculation constraints of the machine, obtaining electromagnetic parameters comprising a back electromotive force and an electromagnetic torque;
wherein in the step 1, nodes are distributed in every solution region of machine, at the interface between two regions and boundary; sub regions to be solved comprise a stator, a slot, an air gap, and a permanent magnet (PM); due to a fact that a rotor core of a SPM machine is generally unsaturated, a Neumann boundary is allowed to be applied to an out surface of a rotor; and there is no need to solve a rotor core region in order to improve a computational efficiency.

2. (canceled)

3. The 2D meshless method according to claim 1, comprising finding a predetermined number of nodes within any sub region as the central node; the nearest adjacent nodes to the central node constitute the support region, and all nodes making up the support region must be within the same sub region.

4. The 2D meshless method according to claim 1, comprising a process of the step 3; in the support region, all nodes are expanded at the central node by a second-order Taylor expansion, and an expression of a remainder term is obtained and multiplied by a weight function to construct a residual function; algebraic equations are obtained according to an extreme value principle; and the operation of solving the algebraic equations is allowed to express the derivative value of each node as a linear combination of the node function values in the support region.

5. The 2D meshless method according to claim 1, wherein in the step 4, the partial differential equations satisfied by each sub region are converted into algebraic equations, wherein a PM region and an air gap region satisfy a Laplace's equation, a slot region satisfies a Poisson equation, and a stator core satisfies a two-dimensional nonlinear partial differential equation.

6. The 2D meshless method according to claim 1, wherein in the step 5, it is necessary to use a node distributed at the interface between two sub regions as the central node to construct the support region within each region, and equations are allowed to be obtained based on the continuity conditions of a magnetic field; nodes distributed on a rotor boundary satisfy a Neumann boundary condition; and nodes on an outer surface of the stator satisfy a Dirichlet boundary condition.

7. The 2D meshless method according to claim 1, wherein in the step 6; a set of algebraic equations are constructed; a coefficient matrix G of the algebraic equations depends on a permeability, node coordinates and weight function; and a source matrix S of the algebraic equations depends on a current density in the slot and a magnetization of a magnet.

8. The 2D meshless method according to claim 1, wherein in the step 7, the vector potential of each node is allowed to be obtained by solving the algebraic equations, and a distribution of flux lines and flux density is allowed to be obtained; and according to the electromagnetic calculation constraints of the machine, the parameters comprising the back electromotive force and electromagnetic torque of the machine are allowed to be obtained.

9. A SPM synchronous machine configured in the 2D meshless method according to claim 1, wherein the SPM synchronous machine is a 12 slot/10 pole three-phase machine wherein the 12 slot/10 pole three-phase machine is allowed to be divided into four parts: the stator, the air gap, the rotor, and a shaft;
the stator comprises a stator yoke, stator teeth, a stator slot, and an armature winding;
an armature slot is a flat bottom slot;
a fractional slot concentrated winding configuration is adopted;
the rotor is cylindrical and PMs are attached to a surface of the rotor;
a material of the PM is neodymium iron boron grade N42UH;
a shape of the PM is a sector shaped and evenly distributed on a circumference of the rotor;
a material of a stator core and the rotor core is silicon steel sheet DW310_35;
the air gap is between the stator and the rotor, with a thickness of 1.5 mm; and
the shaft is made of a nonmagnetic material and the shaft is a solid cylindrical.
